(19) United States
(12) Patent Application Publication
(10) Pub. No.: US 2002/0121190 A1
(43) Pub. Date: Sep. 5, 2002

(54) Cylinder apparatus

(76) Inventor: Takao Nakadate, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/024,562

(22) Filed: Dec. 21, 2001

(30) Foreign Application Priority Data
Dec. 27, 2000 (JP) 398766/2000

(51) Int. Cl. F16J 15/18

(52) U.S. Cl. 92/168

(57) ABSTRACT

A piston connected with a piston rod is slidably fitted in a cylinder having a hydraulic fluid sealed therein. The piston rod extends to the outside of the cylinder through a rod guide fitted to an end portion of the cylinder. An annular seal member is inserted into an annular groove formed on the inner peripheral surface of the rod guide. The piston rod extends through the seal member. A wave washer is inserted into a gap between one end of the annular groove and the seal member. With its spring force, the wave washer urges the seal member to be pressed against the sealing surface of the annular groove. Because the seal member is constantly held in the state of being pressed against the sealing surface irrespective of the stroke direction of the piston rod, stable sealing performance can be obtained, and the leakage of hydraulic fluid can be surely prevented.

### BACKGROUND OF THE INVENTION

The present invention relates to an improvement in cylinder apparatus, e.g. a hydraulic shock absorber attached to a suspension system of a vehicle, for example.

A seal structure for a piston rod of a hydraulic shock absorber in the related art will be described below with reference to FIGS. 4 to 6. As shown in FIG. 4, a hydraulic shock absorber 1 has a double-cylinder structure comprising a cylinder 2 and an outer cylinder 3 provided outside the cylinder 2. A reservoir 4 is formed between the cylinder 2 and the outer cylinder 3. A piston (not shown) connected with a piston rod 5 is slidably fitted in the cylinder 2. The piston divides the inside of the cylinder 2 into a cylinder upper chamber 2a, which is closer to the piston rod 5, and a cylinder lower chamber (not shown), which is remote from the piston rod 5.

A stepped cylinder-shaped rod guide 6 is secured to the upper end portions of the cylinder 2 and the outer cylinder 3. The piston rod 5 extends through the rod guide 6 to the outside of the cylinder 2. The rod guide 6 has a small-diameter portion 7 and a large-diameter portion 8. The small-diameter portion 7 is fitted into the cylinder 2. The large-diameter portion 8 is fitted into the outer cylinder 3. With an annular retainer 9 laid on the upper end of the large-diameter portion 8, the opening portion of the outer cylinder 3 is bent against the retainer 9 at several positions to secure the rod guide 6. Further, a cap 10 is press-fitted onto the outer side of the opening portion of the outer cylinder 3.

As shown in FIG. 5, an annular groove 11 is formed on the inner peripheral portion of the rod guide 6. Further, an enlarged-diameter portion 12 is formed at the side of the annular groove 11 closer to the cylinder upper chamber 2a. The enlarged-diameter portion 12 has a slightly larger diameter than that of the annular groove 11. A seal member 13 with a rectangular sectional configuration is inserted into the annular groove 11 to provide a seal between the rod guide 6 and the piston rod 5. A bush 14 made of a cylindrical metal is press-fitted into the enlarged-diameter portion 12 to guide the sliding movement of the piston rod 5. The inner surface of the bush 14 is coated with a fluorocarbon resin material to smooth the sliding movement of the piston rod 5.

Further, a groove 11b with a small sectional area is provided on the upper end surface of the annular groove 11 to vent only gas, e.g. air, generated in the cylinder 2. Actually, a small amount of hydraulic fluid flows out through the groove 11b. However, it is so small that there will be no influence on damping characteristics and so forth.

A recess 15 is formed around an opening of the rod guide 6 at the end thereof closer to the large-diameter portion 8. A spring-loaded oil seal 16 is secured to the inner peripheral portion of the retainer 9 to provide a seal between the retainer 9 and the piston rod 5. A hydraulic fluid chamber 17 is formed in the recess 15. The rod guide 6 is provided with a hydraulic fluid passage 18 for providing communication between the hydraulic fluid chamber 17 and the reservoir 4. The oil seal 16 has an oil lip 19 provided inside the retainer 9 to make sliding contact with the piston rod 5. The oil seal 16 further has a dust seal 20 provided outside the retainer 9 to make sliding contact with the piston rod 5. Further, the oil seal 16 is provided with a check valve 21 projecting to the outer peripheral side of the oil lip 19 to allow hydraulic fluid to flow through the hydraulic fluid passage 18 only in the direction from the hydraulic fluid chamber 17 to the reservoir 4.

The piston is provided with a hydraulic fluid passage for providing communication between the cylinder upper and lower chambers, together with a damping force generating mechanism (an orifice, a disk valve, etc.) for generating damping force by controlling the flow of hydraulic fluid through the hydraulic fluid passage. The lower end portion of the cylinder 2 is provided with a hydraulic fluid passage for providing communication between the cylinder lower chamber and the reservoir 4, together with a damping force generating mechanism (an orifice, a disk valve, etc.) for controlling the flow of hydraulic fluid through the hydraulic fluid passage. The cylinder 2 has hydraulic fluid sealed therein, and the reservoir 4 has both hydraulic fluid and a gas sealed therein.

The operation of the hydraulic shock absorber 1 will be described below. The flow of hydraulic fluid induced by the sliding movement of the piston in the cylinder 2 in response to the extension and compression strokes of the piston rod 5 is controlled by the damping force generating mechanism provided in the piston and the damping force generating mechanism provided in the lower end portion of the cylinder 2, thereby generating damping force. During the operation, changes in the volumetric capacity of the cylinder 2 caused by the entrance and withdrawal of the piston rod 5 are absorbed by the compression and expansion of the gas in the reservoir 4.

The seal member 13 fitted to the rod guide 6 receives the pressure of hydraulic fluid in the cylinder 2 and allows passage of a slight amount of hydraulic fluid to form a moderate film of hydraulic fluid on the sliding surface of the piston rod 5, thereby reducing the resistance to the sliding movement of the piston rod 5. The film of hydraulic fluid formed on the sliding surface of the piston rod 5 is scraped off with the oil lip 19 of the oil seal 16, thereby preventing the hydraulic fluid from leaking to the outside. Further, external foreign matter attached to the piston rod 5 is wiped off with the dust seal 20, thereby preventing such foreign matter from entering the hydraulic fluid chamber 17. The hydraulic fluid passing through the seal member 13 and scraped off with the oil lip 19 of the oil seal 16 is stored in the hydraulic fluid chamber 17 and then recovered to the reservoir 4 through the hydraulic fluid passage 18 by opening the check valve 21.

Incidentally, the above-described hydraulic shock absorber according to the related art involves the following problems. As shown in FIG. 5, the annular groove 11 of the rod guide 6 has axial and diametrical dimensions set larger than those of the seal member 13 by about 0.5 millimeters in general to absorb volumetric changes of the seal member 13 due to thermal expansion or the like. In addition, the seal member 13 is assembled with a predetermined interference with respect to the piston rod 5 in order to ensure the required sealing performance. Consequently, when the piston rod 5 strokes, the seal member 13 moves within the annular groove 11, together with the piston rod 5 owing to sliding resistance between the seal member 13 and the piston rod 5.

During the extension stroke of the piston rod 5, as shown in FIG. 5, the seal member 13 moves upward and abuts on a sealing surface 11a at the upper end of the annular groove 11 of the rod guide 6. Therefore, the seal member 13 can surely provide the seal between the piston rod 5 and the rod guide 6. However, during the compression stroke of the piston rod 5, the seal member 13 may move downward to separate from the sealing surface 11a of the annular groove 11. In such a case, sealing performance degrades, resulting in an increase in the leakage of hydraulic fluid. Even if the seal member 13 abuts on the upper end of the bush 14, as shown in FIG. 6, because the end surface of the bush 14 is not finished flat, sealing performance may degrade, resulting in a change in the leakage of hydraulic fluid.

If the amount of leakage of hydraulic fluid changes as stated above, damping characteristics become unstable.

The present invention was made in view of the above-described circumstances. Accordingly, an object of the present invention is to provide a cylinder apparatus, e.g. a hydraulic shock absorber, capable of obtaining stable sealing performance irrespective of the stroke direction or speed of the piston rod.

### SUMMARY OF THE INVENTION

To solve the above-described problem, the invention of this application provides a cylinder apparatus comprising a cylinder having a hydraulic fluid sealed therein; a piston slidably fitted in the cylinder; a rod guide fitted to an end portion of the cylinder; a piston rod connected to the piston, the piston rod extending through the rod guide to the outside of the cylinder; an annular seal member inserted into an annular groove formed on the inner peripheral surface of the rod guide to provide a seal between the rod guide and the piston rod, the piston rod extending through the annular seal member; and an annular wave-type washer inserted into a gap between one end of the annular groove and the seal member to urge the seal member to be pressed against the other end of the annular groove.

With the above-described arrangement, the seal member is held in the state of being pressed against the end of the annular groove by the urging means irrespective of the stroke direction of the piston rod.

The washer is preferably formed so that the difference between the outer diameter of the washer and the inner diameter of the annular groove is smaller than the difference between the inner diameter of the washer and the outer diameter of the piston rod. With this arrangement, there is no possibility of the piston rod and the washer coming into contact with each other.

The configuration of the washer is preferably such that the washer has convexly curved portions and concavely curved portions alternately provided in the circumferential direction, and the number of convexly curved portions is at least three, and further the spacing between each pair of adjacent convexly curved portions is at least 10 millimeters. With this arrangement, the washer can stably urge the seal member.

In addition, the invention of this application provides a cylinder apparatus comprising a cylinder having a hydraulic fluid sealed therein; a piston slidably fitted in the cylinder; a rod guide fitted to an end portion of the cylinder; a piston rod connected to the piston, the piston rod extending through the rod guide to the outside of the cylinder; an oil seal provided on a side of the rod guide closer to the projecting end of the piston rod to isolate the inside and outside of the cylinder apparatus from each other; an annular seal member provided inside the oil seal and inserted into an annular groove formed on the inner peripheral surface of the rod guide to provide a seal between the rod guide and the piston rod, the piston rod extending through the annular seal member; and an annular urging means inserted into a gap between one end of the annular groove and the seal member to urge the seal member to be pressed against the other end of the annular groove.

With the above-described arrangement, the seal member is held in the state of being pressed against the end of the annular groove by the urging means irrespective of the stroke direction of the piston rod.

The urging means is preferably a wave-type washer. With the above-described arrangement, the seal member is held in the state of being pressed against the end of the annular groove by the urging means approximately uniformly in the radial direction irrespective of the stroke direction of the piston rod.

The washer is preferably formed so that the difference between the outer diameter of the washer and the inner diameter of the annular groove is smaller than the difference between the inner diameter of the washer and the outer diameter of the piston rod. With this arrangement, there is no possibility of the piston rod and the washer coming into contact with each other.

The configuration of the washer is preferably such that the washer has convexly curved portions and concavely curved portions alternately provided in the circumferential direction, and the number of convexly curved portions is at least three, and further the spacing between each pair of adjacent convexly curved portions is at least 10 millimeters. With this arrangement, the washer can stably urge the seal member.

### BRIEF DESCRIPTION OF THE DRAWINGS

FIG. 1 is an enlarged vertical sectional view showing a seal part of a piston rod in a hydraulic shock absorber according to an embodiment of the present invention.

FIG. 2 is a perspective view of a fragment corresponding to a 45-degree portion of a wave washer provided in the seal part shown in FIG. 1.

FIG. 3 is a diagram of the wave washer provided in the seal part shown in FIG. 1, as seen from the direction of the center axis of the wave washer.

FIG. 4 is a vertical sectional view showing a seal part of a piston rod in a hydraulic shock absorber according to the related art.

FIG. 5 is an enlarged vertical sectional view showing the state of the seal part during the extension stroke of the piston rod in the hydraulic shock absorber shown in FIG. 4.

FIG. 6 is an enlarged vertical sectional view showing the state of the seal part during the compression stroke of the piston rod in the hydraulic shock absorber shown in FIG. 4.

### DETAILED DESCRIPTION OF THE INVENTION

An embodiment of the present invention will be described below in detail with reference to the accompanying drawings. It should be noted that this embodiment is generally similar in arrangement to the above-described related art except the seal structure provided between the rod guide and the piston rod. Therefore, portions of this embodiment that are similar to those in the related art are denoted by the same reference numerals, and only the portions in which this embodiment differs from the related art will be described in detail.

In the hydraulic shock absorber according to this embodiment, as shown in FIG. 1, an annular groove 11 is formed on the inner peripheral portion of the rod guide 6. Further, an enlarged-diameter portion 12 is formed at the side of the annular groove 11 closer to the cylinder upper chamber 2a. The enlarged-diameter portion 12 has a slightly larger diameter than that of the annular groove 11. A seal member 13 (seal means) with a rectangular sectional configuration made of a resin material is inserted into the annular groove 11 to provide a seal between the rod guide 6 and the piston rod 5. A bush 14 made of a cylindrical metal is press-fitted into the enlarged-diameter portion 12 to guide the sliding movement of the piston rod 5. The inner surface of the bush 14 is coated with a fluorocarbon resin material to smooth the sliding movement of the piston rod 5.

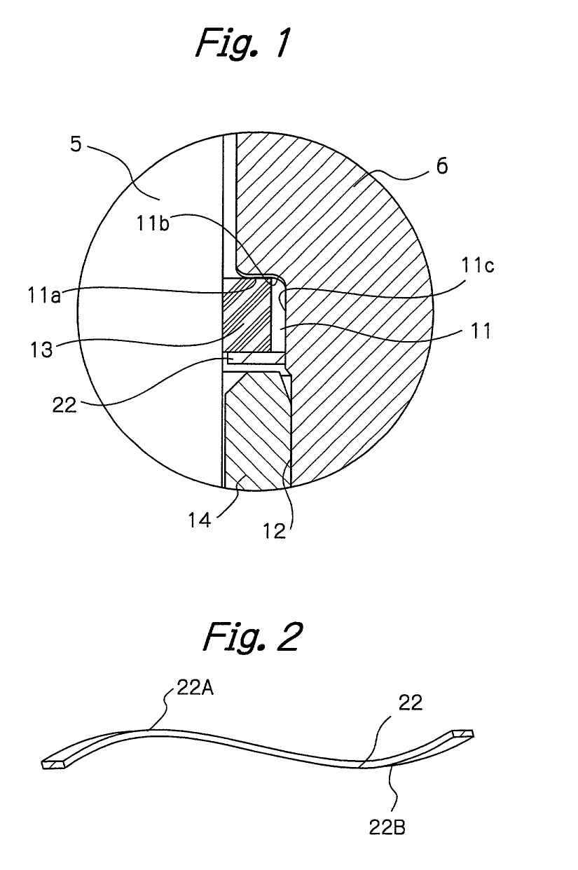

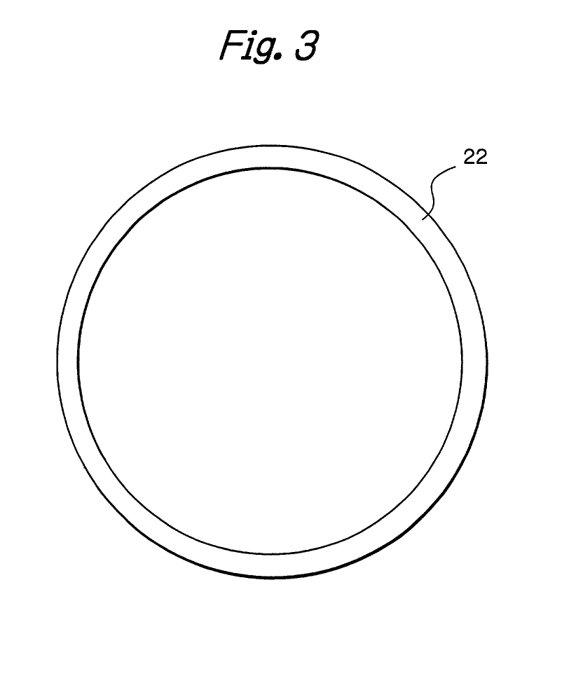

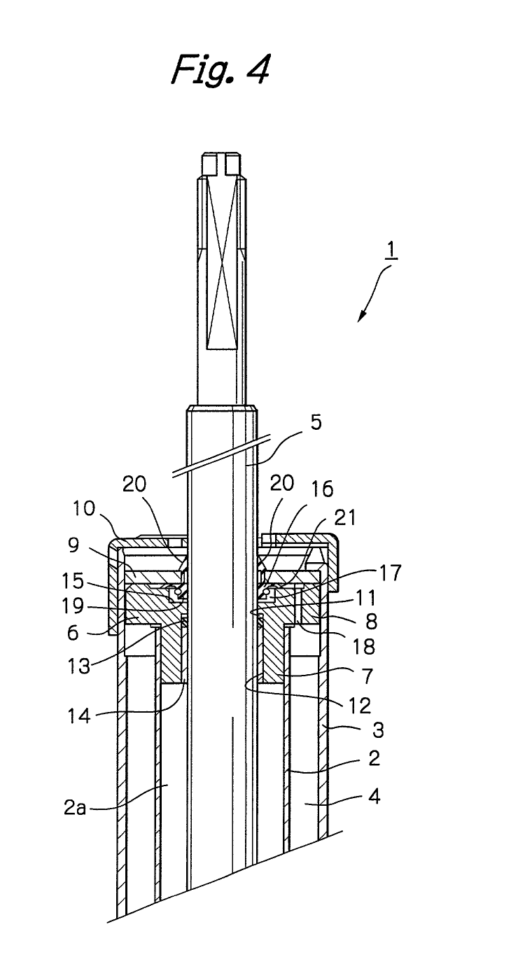

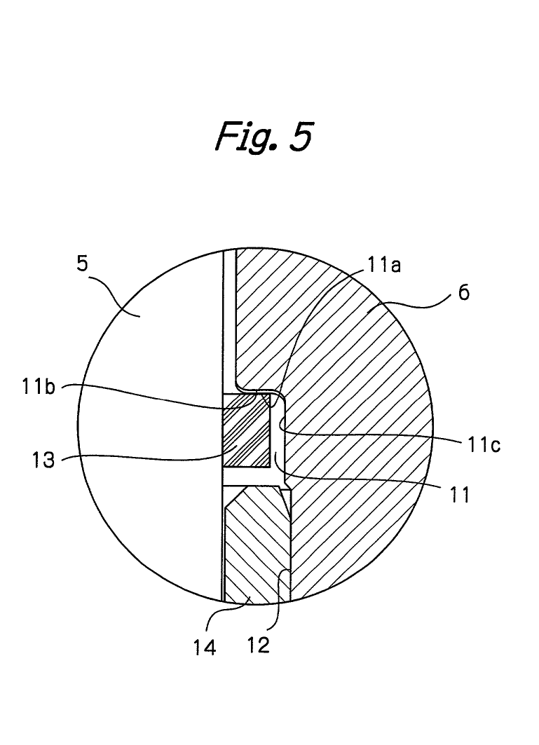

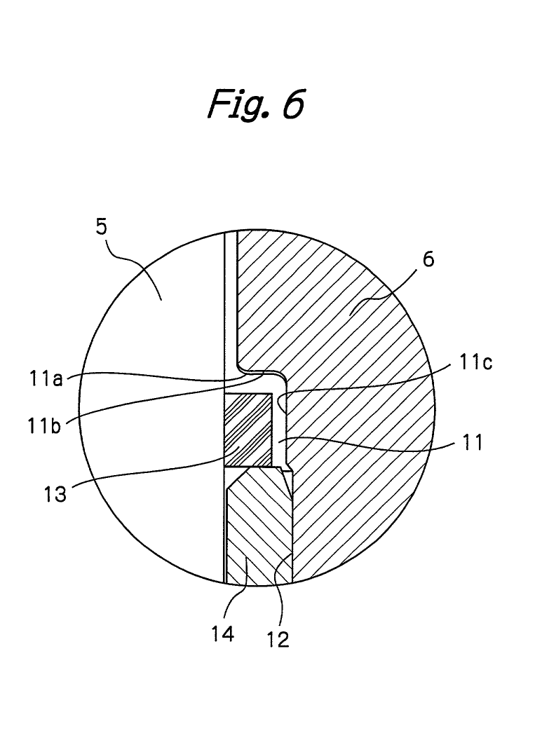

A wave washer 22 (urging means) is inserted into a gap between the upper end of the bush 14 and the lower end of the seal member 13. The wave washer 22 is, as shown in FIGS. 2 and 3, a washer without a cut, which is produced by forming an annular metal into a wavy shape so as to be resilient as a whole. With its spring force, the wave washer 22 constantly urges the seal member 13 in the axial direction of the hydraulic shock absorber so that the seal member 13 is pressed against a sealing surface 11a at the upper end of the annular groove 11.

The wave washer 22 has eight wavy portions rising and falling alternately in the circumferential direction. The wavy portions consist of four convexly curved portions 22A and four concavely curved portions 22B. The convexly curved portions 22A and the concavely curved portions 22B are alternately disposed along the circumferential direction. The wave washer 22 has an initial load applied thereto in the assembled state, so that the area of contact between the seal member 13 and each of the four convexly curved portions 22A is relatively wide.

When the seal member 13 made of a resin material is urged to be pressed against the sealing surface 11a as in this embodiment, if the number of convexly curved portions 22A at which the wave washer 22 is in contact with the seal member 13 increases and hence the spacing between each pair of adjacent convexly curved portions 22A narrows, the area of contact per contact interface decreases. This may cause the seal member 13 to be dented or damaged. Therefore, it is desirable that the spacing (in terms of the inner circumferential length) between each pair of adjacent convexly curved portions 22A should be at least 10 millimeters. It is also desirable that the number of convexly curved portions 22A should be at least three in consideration of the prevention of tilting of the seal member 13.

Further, the wave washer 22 has an outer diameter set approximately equal to the inner diameter of the annular groove 11. Thus, positioning of the wave washer 22 is effected by contact between the inner peripheral portion 11c of the annular groove 11 and the outer peripheral portion 22A of the wave washer 22. Further, the inner diameter of the wave washer 22 is set larger than the outer diameter of the piston rod 5. Thus, the inner peripheral portion 22B of the wave washer 22 is prevented from contacting the piston rod 5.

Although in the foregoing the outer diameter of the wave washer 22 is set approximately equal to the inner diameter of the annular groove 11, it should be noted that the present invention is not necessarily limited to the described arrangement. It is possible to prevent the wave washer 22 from contacting the piston rod 5 as long as the difference (gap) between the outer diameter of the wave washer 22 and the inner diameter of the annular groove 11 is smaller than the difference (gap) between the inner diameter of the wave washer 22 and the outer diameter of the piston rod 5.

It should be noted that the initial load for the spring force of the wave washer 22 is set larger than binding force produced by the interference of the seal member 13 with respect to the piston rod 5, that is, static friction occurring as sliding resistance, so that even when the piston rod 5 strokes in the direction of contraction, the seal member 13 can be held in the state of being pressed against the sealing surface 11a with sufficient force.

The operation of this embodiment arranged as stated above will be described below.

Even during the compression stroke of the piston rod 5, the seal member 13 is constantly pressed against the sealing surface 11a of the annular groove 11 and held in this position by the spring force of the wave washer 22, overcoming sliding resistance between the seal member 13 and the piston rod 5. Therefore, stable sealing performance can be obtained, and it is possible to surely prevent leakage of hydraulic fluid irrespective of the stroke direction of the piston rod 5. Further, because the seal member 13 will not move within the annular groove 11, together with the piston rod 5, it is possible to reduce wear and so forth and hence possible to improve durability.

In addition, because the wavy configuration of the wave washer 22 allows a plurality of gaps to be formed between the wave washer 22 and the seal member 13, volumetric changes of the seal member 13 due to thermal expansion or the like can be absorbed by the resilience of the wave washer 22 and also accommodated by the gaps. Therefore, it is possible to prevent the increase in sliding resistance due to thermal expansion of the seal member 13 or the like. Thus, it is possible to ensure stable sliding performance of the piston rod 5.

Although the foregoing embodiment uses the wave washer 22 as an example of the urging means, it should be noted that the present invention is not necessarily limited to the wave washer 22. It is also possible to use a washer having other configuration, a coil spring, an O-ring made of a rubber material, etc. as the urging means as long as it is possible to urge the seal member 13 in the axial direction so that the seal member 13 is constantly pressed against the sealing surface 11a of the annular groove 11.

However, for a seal member 13 in which one side of the cross-section is as small as about 2 to 3 millimeters, it is practically difficult to insert a coil spring or an O-ring. In this regard, the above-described wave washer 22 is easy to install.

Further, when a coil spring is used, the upper end of the coil spring is in line contact with the lower surface of the seal member 13 in the circumferential direction. Therefore, the position where the coil spring contacts the seal member 13 may be displaced in the radial direction (i.e. the coil spring may be decentered with respect to the seal member 13). If such occurs, the coil spring undesirably generates force that causes the seal member 13 to tilt with respect to the axis of the piston rod 5. Consequently, the upper or lower end portion of the seal member 13 is brought into strong contact with the piston rod 5. Thus, stable sealing performance cannot be obtained. When the wave washer 22 is used, however, force acts on the seal member 13 approximately uniformly in the radial direction. Therefore, force that causes tilt is unlikely to be applied to the seal member 13. Accordingly, stable sealing performance can be ensured.

Further, when a coil spring is used, the upper end of the coil spring may be displaced in the radial direction to come in contact with the piston rod 5. When an O-ring is used, it may come into contact with the piston rod 5 upon deformation thereof. Thus, when a coil spring or an O-ring is used, it is necessary to design the seal structure so that the coil spring or the O-ring will not contact the piston rod 5 even when it is displaced to a maximum extent in the radial direction. Accordingly, there is difficulty in designing, and the degree of design freedom reduces unfavorably. However, the wave washer 22 cannot contact the piston rod 5 as long as the seal structure satisfies the condition that the difference (gap) between the inner diameter of the wave washer 22 and the outer diameter of the piston rod 5 is larger than the difference (gap) between the outer diameter of the wave washer 22 and the inner diameter of the annular groove 11. Therefore, the seal structure is easy to design.

Further, although in the foregoing embodiment the present invention is applied to a double-cylinder type hydraulic shock absorber by way of example, the present invention is not necessarily limited thereto but may be widely applied to various cylinder apparatus, e.g. a cylinder apparatus for a single-cylinder type hydraulic shock absorber or an active suspension system.

As has been detailed above, the cylinder apparatus according to the foregoing embodiment is arranged as follows. The annular seal member 13 through which the piston rod 5 extends is inserted into the annular groove 11 formed on the inner peripheral surface of the rod guide 6, and the annular wave washer 22 is inserted into the gap between one end of the annular groove 11 and the seal member 13 to urge the seal member 13 to be pressed against the other end of the annular groove 11. Accordingly, the seal member 13 is constantly held in the state of being pressed against the end of the annular groove 11 by the wave washer 22 irrespective of the stroke direction of the piston rod 5. Therefore, stable sealing performance can be obtained, and it is possible to surely prevent leakage of hydraulic fluid irrespective of the stroke direction of the piston rod 5.

In addition, because the wavy configuration of the wave washer 22 allows a plurality of gaps to be formed between the wave washer 22 and the seal member 13, volumetric changes of the seal member 13 due to thermal expansion or the like can be absorbed by the gaps between the seal member 13 and the wave washer 22. As a result, it is possible to prevent the increase in sliding resistance to the piston rod 6 due to thermal expansion of the seal member 13 or the like. Thus, the piston rod is allowed to stroke smoothly.

Further, because the difference between the outer diameter of the wave washer 22 and the inner diameter of the annular groove 11 is smaller than the difference between the inner diameter of the wave washer 22 and the outer diameter of the piston rod 5, it is possible to prevent the wave washer 22 from contacting the piston rod 5.

The seal member 13 can be stably urged by the configuration of the wave washer 22 in which the convexly curved portions 22A and the concavely curved portions 22B are alternately disposed along the circumferential direction, and the number of convexly curved portions 22A is at least three, and further the spacing between each pair of adjacent convexly curved portions 22A is at least 10 millimeters.

The entire disclosure of Japanese Patent Application No. 2000-398766 filed on Dec. 27, 2000 including specification, claims, drawings and summary is incorporated herein by reference in its entirety.

What is claimed is:

1. A cylinder apparatus comprising:
a cylinder having a hydraulic fluid sealed therein;
a piston slidably fitted in said cylinder;
a rod guide fitted to an end portion of said cylinder;
a piston rod connected to said piston, said piston rod extending through said rod guide to an outside of said cylinder;
an annular seal member inserted into an annular groove formed on an inner peripheral surface of said rod guide to provide a seal between said rod guide and said piston rod;
said piston rod extending through said annular seal member; and
an annular wave-type washer inserted into a gap between one end of said annular groove and said seal member to urge said seal member to be pressed against the other end of said annular groove.

2. A cylinder apparatus according to claim 1, wherein a difference between an outer diameter of said washer and an inner diameter of said annular groove is smaller than a difference between an inner diameter of said washer and an outer diameter of said piston rod.

3. A cylinder apparatus according to claim 1, wherein said washer comprises convexly curved portions and concavely curved portions alternately provided in a circumferential direction, wherein the number of said convexly curved portions is at least three, and a spacing between each pair of adjacent convexly curved portions is at least 10 millimeters.

4. A cylinder apparatus comprising:
a cylinder having a hydraulic fluid sealed therein;
a piston slidably fitted in said cylinder;
a rod guide fitted to an end portion of said cylinder;
a piston rod connected to said piston, said piston rod extending through said rod guide to an outside of said cylinder;
an oil seal provided on a side of said rod guide closer to a projecting end of said piston rod to isolate an inside and outside of said cylinder apparatus from each other;
an annular seal member provided inside said oil seal and inserted into an annular groove formed on an inner peripheral surface of said rod guide to provide a seal between said rod guide and said piston rod;
said piston rod extending through said annular seal member; and
annular urging means inserted into a gap between one end of said annular groove and said seal member to urge said seal member to be pressed against the other end of said annular groove.

5. A cylinder apparatus according to claim 4, wherein said urging means is a wave-type washer.

6. A cylinder apparatus according to claim 5, wherein a difference between an outer diameter of said washer and an inner diameter of said annular groove is smaller than a difference between an inner diameter of said washer and an outer diameter of said piston rod.

7. A cylinder apparatus according to claim 5, wherein said washer comprises convexly curved portions and concavely curved portions alternately provided in a circumferential direction, wherein the number of said convexly curved portions is at least three, and a spacing between each pair of adjacent convexly curved portions is at least 10 millimeters.
